(19) United States
(12) Patent Application Publication
(10) Pub. No.: US 2023/0354793 A1
(43) Pub. Date: Nov. 9, 2023

(54) Rattle Reel

(71) Applicants: Robert Bryce, Swanville, MN (US); Eric Matthew Koetter, Swanville, MN (US); Nathaniel David Koetter, Swanville, MN (US); Samuel David Cange, Burtrum, MN (US)

(72) Inventors: Robert Bryce, Swanville, MN (US); Eric Matthew Koetter, Swanville, MN (US); Nathaniel David Koetter, Swanville, MN (US); Samuel David Cange, Burtrum, MN (US)

(21) Appl. No.: 17/737,801

(22) Filed: May 5, 2022

(51) Int. Cl. A01K 89/015; A01K 97/12

(52) U.S. Cl. CPC A01K 89/0179; A01K 97/125

(57) ABSTRACT

The present invention is a rattle reel for catching fish. The rattle reel has a wall bracket, a reel arm, and a reel. The wall bracket is a U-shaped component that attached the present invention to a wall. The reel arm is a post that connects the reel to the wall bracket. The wall bracket has a plurality of screw holes, a pivot brushing, a clamp, a wall-facing side, and an arm sleeve. The pivot brushing is a hinge that allows the reel arm to rotate. The reel arm has a battery housing, a power switch, and an alarm housing. The reel has a light, a rattle mechanism, a handle, a tension adjuster, and an alarm adjuster. The tension adjuster is an axle that controls the rotating speed of the reel. The wall bracket is fixed at the end of the reel arm and extends away from the wall bracket. The reel is placed at the opposite side of the wall bracket to ensure the structural object the present invention is attached to is not in the way of the reel.

### FIELD OF THE INVENTION

The present invention relates generally to a rattle fishing reel. More specifically the present invention is a fishing reel that has an additional audible alarm and light to indicate a caught fish.

### BACKGROUND OF THE INVENTION

Fishing is a time-consuming pastime that requires much patience and attention to efficiently attract and catch fish. In some instances, fishermen set up various fishing lines in an attempt to try and catch multiple fish at once. This requires greater attention to monitor each of the fishing lines to be aware once a fish has been attracted to the line. Many rattle reels have been introduced to fishing in an attempt to notify the fisher once a fish has bit the line and attempted to swim away. These rattle reels create an audible noise to alert the fisher that their attention is needed at that specific fishing reel.

### BRIEF DESCRIPTION OF THE DRAWINGS

FIG. 1 is a perspective view of the present invention.

FIG. 2 is a side view of the present invention.

FIG. 3 is block diagram showing the electrical connections between the components of the present invention.

### DETAIL DESCRIPTIONS OF THE INVENTION

All illustrations of the drawings are for the purpose of describing selected versions of the present invention and are not intended to limit the scope of the present invention.

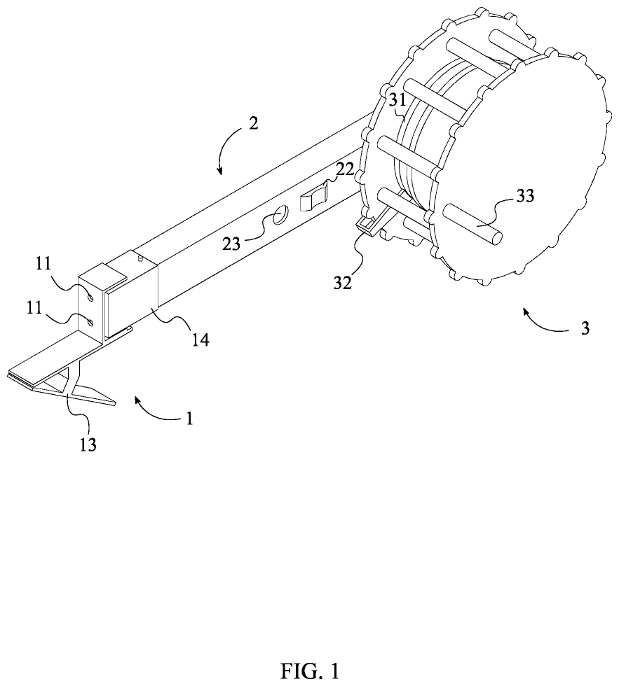

In reference to FIG. 1, the present invention is a rattle reel for catching fish. The rattle reel comprises a wall bracket 1, a reel arm 2, and a reel 3. The wall bracket 1 is a structural member that secures the present invention to an outer structure. The reel arm 2 is an elongated member that secures terminally connects the reel 3 to the wall bracket 1. The wall bracket 1 comprises a plurality of screw holes 11, a pivot brushing 12, a clamp 13, a wall-facing side, and an arm sleeve 14. The pivot brushing 12 is a cylindrical member that allows the reel arm 2 to rotate around. The reel arm 2 comprises a battery housing 21, a power switch 22, and an alarm housing 23. The reel 3 comprises a light 31, a rattle mechanism 32, a handle 33, a tension adjuster 34, and an alarm sensor 35. The tension adjuster 34 is a mechanical piece that controls the rotational force allowed by the reel 3. The wall bracket 1 is terminally fixed to the reel arm 2. Therefore, the reel arm 2 extends away from the wall bracket 1. The reel 3 is terminally fixed to the reel arm 2 opposite the wall bracket 1. Thus, the reel 3 is positioned away from the wall bracket 1.

Further, the plurality of screw holes 11 is positioned along the wall-facing side of the wall bracket 1. Accordingly, the plurality of screw holes 11 is positioned in a way that allows the present invention to be secured to an external surface via screws or other fastening means. As shown in FIG. 1, the plurality of screw holes 11 traverses through the wall bracket 1. Consequently, the plurality of screw holes 11 allows a screw or other fastener to pass through the wall bracket 1 to secure the present invention.

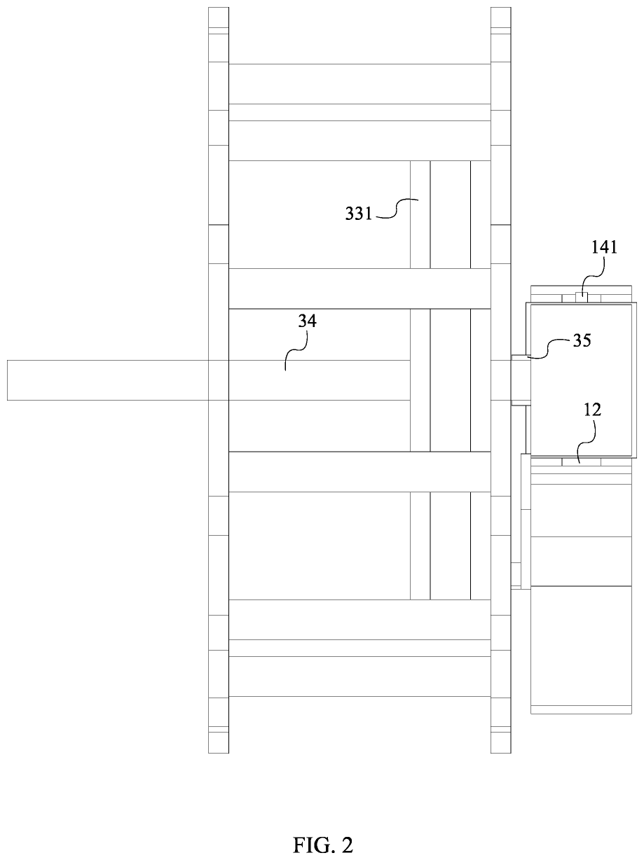

Furthermore, the pivot brushing 12 rotatably connects the arm sleeve 14 to the wall bracket 1. As a result, the pivot brushing 12 allows the arm sleeve 14 to rotate and pivot around the wall bracket 1. This ensures the arm sleeve 14 one degree of motion around the wall bracket 1. Shown in FIG. 2, the pivot brushing 12 is a cylindrical member to facilitate rotational movement around the axis. The pivot brushing 12 can easily turn with the cylindrical shape and metal material.

In reference to FIG. 2, the arm sleeve 14 further comprises a push button 141. The push button 141 is a short cylindrical button that depresses when pressed. The push button 141 mechanically releases the arm from the arm sleeve 14. Thus, arm is secured within the arm sleeve 14 until the push button 141 unlocks the mechanical connection. The clamp 13 is positioned terminally along the wall bracket 1. So, the clamp 13 can support the terminal end of the present invention at the wall bracket 1. The clamp 13 secures the present invention to an exterior surface. Accordingly, the clamp 13 allows for a convenient and removable fixation to an exterior surface.

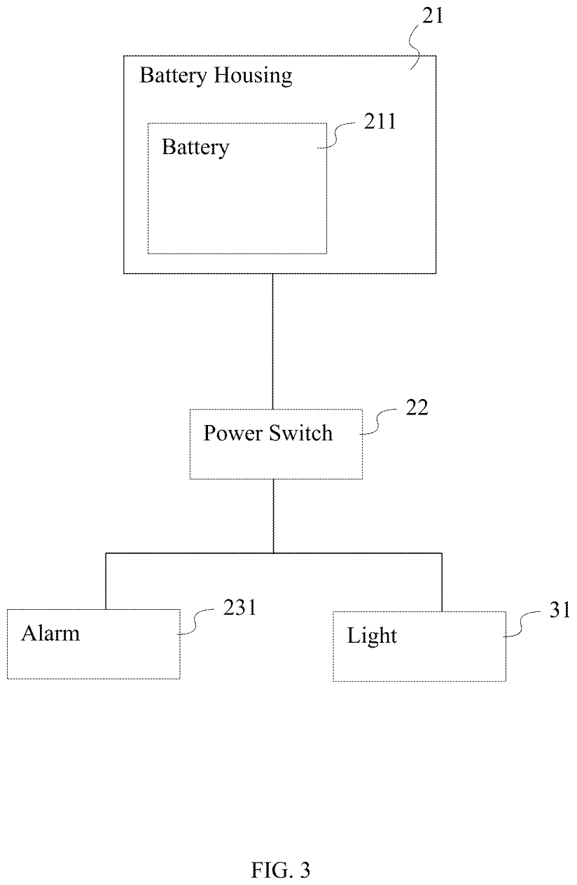

In reference to FIG. 3, the battery housing 21 is mounted within the reel arm 2. Consequently, the battery housing 21 is positioned within the reel arm 2 to prevent exposure to any harmful outside elements. The battery housing 21 receives a battery 211 to power the present invention. As a result, the battery housing 21 mechanically secures a battery 211 within the present invention and sends the electrical power from the battery 211 to the other electrical components. The power switch 22 is positioned offset the battery housing 21. Thus, the power switch 22 is accessible from the outside of the present invention.

Further, the alarm housing 23 is positioned offset the power switch 22. So, the alarm housing 23 does not interfere with the power switch 22. The power switch 22 is positioned between the alarm housing 23 and the battery housing 21. Accordingly, the power switch 22 easily controls the flow of power from the battery housing 21 to the alarm housing 23. Shown in FIG. 1, the alarm housing 23 consists of a circular shape. Consequently, the alarm housing 23 allows audible sounds to exit the alarm housing 23. The alarm housing 23 further comprises an alarm 231. The alarm 231 produces an audible sound. As a result, the alarm 231 creates an adjustable noise to alert changes to the reel 3 rotation. The power switch 22 controls the alarm 231 and light 31. Thus, the power switch 22 opens and closes the flow of power to the alarm 231 and power switch.

Furthermore, the light 31 further comprises a light cover 311. The light 31 is a disc shape as seen in FIG. 1. So, the light 31 can rotate without creating a flickering or rotational visualization. The light 31 is positioned within the reel 3. Accordingly, the light 31 brightens the reel 3 while the wheel is rotating. The light cover 311 is a semi-transparent material. Consequently, the light 31 from the light 31 can still travel through the light cover 311. The light cover 311 is a light grey color.

In reference to FIG. 2, the rattle mechanism 32 is fixed within the reel 3. As a result, the rattle mechanism 32 rotates with the rotation of the wheel. The reel 3 rotates around the tension adjuster 34. Thus, the reel 3 rotates in place and does not move positionally. The rattle mechanism 32 creates a noise during the reel 3 rotation. So, the rattle mechanism 32 produces a gentle noise was the reel 3 rotates and stops once the reel 3 rotation ends. The handle 33 is fixed along the outside of the reel 3. Accordingly, the handle 33 rotates along with the reel 3 rotation and can further be used to rotate the reel 3 with a radial force applied.

Additionally, the tension adjuster 34 is centrally located on the reel 3 as seen in FIG. 2. Consequently, the tension adjuster 34 is positioned concentrically to the reel 3 diameter. The reel 3 rotates around the tension adjuster 34. As a result, the tension adjuster 34 is used as a rotating axle for the reel 3. The tension adjuster 34 controls the allowable tension for reel 3 rotation. Thus, the tension adjuster 34 makes it harder or easier for the reel 3 to rotated.

In reference to FIG. 3, the alarm sensor 35 is positioned within the reel 3. So, the alarm sensor 35 moves with the reel 3 rotation. The alarm sensor 35 detects reel 3 rotation. Accordingly, the alarm sensor 35 determines movement within the reel 3. The alarm sensor 35 is electrically connected to the light 31, alarm 231, and battery 211. Consequently, the alarm sensor 35 can send an electrical signal to the alarm 231 and light 31 to indicate reel 3 rotation.

Although the invention has been explained in relation to its preferred embodiment, it is to be understood that many other possible modifications and variations can be made without departing from the spirit and scope of the invention as hereinafter claimed.

What is claimed is:

1. A rattle reel comprising:
a wall bracket;
a reel arm;
a reel;
the wall bracket comprising a plurality of screw holes, a pivot brushing, a clamp, a wall-facing side, and an arm sleeve;
the reel arm comprising a battery housing, a power switch, and an alarm housing;
the reel comprising a light, a rattle mechanism, a handle, a tension adjuster, and an alarm sensor;
the wall bracket being terminally fixed to the reel arm; and
the reel being terminally fixed to the reel arm opposite the wall bracket.

2. The rattle reel as claimed in claim 1 comprising:
the plurality of screw holes being positioned along the wall-facing side of the wall bracket; and
the plurality of screw holes traversing through the wall bracket.

3. The rattle reel as claimed in claim 1 comprising:
the pivot brushing rotatably connecting the arm sleeve to the wall bracket; and
the pivot brushing being a cylindrical member to facilitate rotational movement around the axis.

4. The rattle reel as claimed in claim 1 comprising:
the arm sleeve further comprising a push button; and
the push button mechanically releasing the arm from the arm sleeve.

5. The rattle reel as claimed in claim 1 comprising:
the clamp being positioned terminally along the wall bracket; and
the clamp securing the present invention to an exterior surface.

6. The rattle reel as claimed in claim 1 comprising:
the battery housing being mounted within the reel arm; and
the battery housing receiving a battery to power the present invention.

7. The rattle reel as claimed in claim 1 comprising, the power switch being positioned offset the battery housing.

8. The rattle reel as claimed in claim 1 comprising:
the alarm housing being positioned offset the power switch;
the power switch being positioned between the alarm housing and the battery housing; and
the alarm housing consisting of a circular shape.

9. The rattle reel as claimed in claim 8 comprising:
the alarm housing further comprising an alarm;
the alarm producing an audible sound; and
the power switch controlling the alarm and light.

10. The rattle reel as claimed in claim 1 comprising:
the light further comprising a light cover;
the light being a disc shape; and
the light being positioned within the reel.

11. The rattle reel as claimed in claim 10 comprising:
the light cover being a semi-transparent material; and
the light cover being a light grey color.

12. The rattle reel as claimed in claim 1 comprising:
the rattle mechanism being fixed within the reel;
the reel rotating around the tension adjuster;
the rattle mechanism creating a noise during the reel rotation; and
the handle being fixed along the outside of the reel.

13. The rattle reel as claimed in claim 1 comprising:
the tension adjuster being centrally located on the reel;
the reel rotating around the tension adjuster; and
the tension adjuster controlling the allowable tension for reel rotation.

14. The rattle reel as claimed in claim 1 comprising:
the alarm sensor being positioned within the reel;
the alarm sensor detecting reel rotation; and
the alarm sensor being electrically connected to the light, alarm, and battery.

15. A rattle reel comprising:
a wall bracket;
a reel arm;
a reel;
the wall bracket comprising a plurality of screw holes, a pivot brushing, a clamp, a wall-facing side, and an arm sleeve;
the reel arm comprising a battery housing, a power switch, and an alarm housing;
the reel comprising a light, a rattle mechanism, a handle, a tension adjuster, and an alarm sensor;
the wall bracket being terminally fixed to the reel arm;
the reel being terminally fixed to the reel arm opposite the wall bracket;
the plurality of screw holes being positioned along the wall-facing side of the wall bracket;
the plurality of screw holes traversing through the wall bracket;
the pivot brushing rotatably connecting the arm sleeve to the wall bracket; and
the pivot brushing being a cylindrical member to facilitate rotational movement around the axis.

16. The rattle reel as claimed in claim 15 comprising:
the arm sleeve further comprising a push button;
the push button mechanically releasing the arm from the arm sleeve;
the clamp being positioned terminally along the wall bracket; and
the clamp securing the present invention to an exterior surface.

17. The rattle reel as claimed in claim 15 comprising:
the battery housing being mounted within the reel arm;
the battery housing receiving a battery to power the present invention; and
the power switch being positioned offset the battery housing.

18. The rattle reel as claimed in claim 15 comprising:
the alarm housing being positioned offset the power switch;
the power switch being positioned between the alarm housing and the battery housing;
the alarm housing consisting of a circular shape;
the alarm housing further comprising an alarm;
the alarm producing an audible sound;
the power switch controlling the alarm and light;
the light further comprising a light cover;
the light being a disc shape; and
the light being positioned within the reel.

19. The rattle reel as claimed in claim 18 comprising:
the light cover being a semi-transparent material; and
the light cover being a light grey color.

20. The rattle reel as claimed in claim 15 comprising:
the rattle mechanism being fixed within the reel;
the reel rotating around the tension adjuster;
the rattle mechanism creating a noise during the reel rotation;
the handle being fixed along the outside of the reel;
the tension adjuster being centrally located on the reel;
the reel rotating around the tension adjuster;
the tension adjuster controlling the allowable tension for reel rotation;
the alarm sensor being positioned within the reel;
the alarm sensor detecting reel rotation; and
the alarm sensor being electrically connected to the light, alarm, and battery.
